(19) United States
(12) Patent Application Publication
(10) Pub. No.: US 2024/0037371 A1
(43) Pub. Date: Feb. 1, 2024

(54) DETECTING AUDIBLE REACTIONS DURING VIRTUAL MEETINGS

(71) Applicant: Zoom Video Communications, Inc., San Jose, CA (US)

(72) Inventors: Yuhui Chen, San Jose, CA (US); Qiang Gao, Charlotte, NC (US); Zhaofeng Jia, Saratoga, CA (US); Rongrong Liu, Sunnyvale, CA (US)

(73) Assignee: Zoom Video Communications, Inc., San Jose, CA (US)

(21) Appl. No.: 17/873,279

(22) Filed: Jul. 26, 2022

(51) Int. Cl. G06N 3/04; G06N 20/00; H04N 7/15; H04H 60/58

(52) U.S. Cl. CPC G06N 3/0454; G06N 20/00; H04N 7/155; H04H 60/58

(57) ABSTRACT

One example method includes receiving, by a machine learning (“ML”) model of a conference client application, audio signals received from a microphone of a client device, the client device connected to a virtual meeting via the conference client application, the virtual meeting hosted by a virtual conference provider; determining, by the ML model, a plurality of candidate reactions associated with the audio signals, the ML comprising a plurality of convolutional neural network (“CNN”) layers and at least one fully connected layer; selecting a reaction from the plurality of candidate reactions; and transmitting the reaction to the virtual conference provider.

### FIELD

This application generally relates to virtual conferencing and more particularly relates to detecting audible reactions during virtual meetings.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-3 are example systems for detecting audible reactions during virtual meetings;

FIG. 4 shows an example client device for detecting audible reactions during virtual meetings;

FIG. 5 shows an example audible reaction detection system for detecting audible reactions during virtual meetings;

FIG. 6 shows an additional feature of an example ML model that can improve computational cost and memory use;

FIG. 7 shows an example virtual conference provider configured to provide aggregated reactions;

FIG. 8 shows an example graphical user interface for providing reactions during a virtual meeting; and

FIGS. 9-10 show example methods for detecting audible reactions during virtual meetings.

FIG. 11 shows an example computing device suitable for systems and methods for detecting audible reactions during virtual meetings.

### DETAILED DESCRIPTION

Examples are described herein in the context of detecting audible reactions during virtual meetings. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Virtual conference providers can enable people to interact with each other using their own computers (or “client devices”) with both video and audio in a variety of settings, such as in one-on-one conversations, group meetings, and webinars. While each of these types of settings can allow people to interact with each other, they can differ in character. For example, one-on-one conversations include only two people and may involve only a small amount of data being transmitted between the two client devices. Group meetings may involve a larger number of people all interacting with each other. In contrast, webinars typically involve a group of people that are attending to hear presentations from one or more presenters. Thus, in a webinar, interaction tends to be mostly one-way: from the presenter(s) to the audience. In addition, webinars can have very large numbers of participants, potentially numbering in the thousands or tens of thousands.

Because some virtual conferences, such as webinars, can include very large numbers of participants, hosts of such virtual conferences will often prevent participants, other than presenters, moderators, or panelists from speaking in the meeting. As a result, participants are significantly restricted in the kinds of feedback they can provide to those speaking during the virtual conference. In addition, the speakers experience little to no audience reaction to their presentations. Thus, the speakers and participants may feel disconnected from each other, with the participants feeling as though they are watching a television program, while the speakers feeling as though they are simply recording a presentation for later viewing.

To allow participants to provide feedback, the participants may enable their microphones in virtual conferencing applications (or “client applications”) that the participants use to connect to the virtual meeting during the virtual conference, despite the audio not being provided to the presenters. The client applications can then monitor the received audio for certain types of audible feedback, such as clapping, cheering, or laughing. When such feedback is recognized, the client application can provide an indication of the recognized feedback to the virtual conference provider. If multiple different participants provide the same kind of feedback at about the same time, the virtual conference provider can aggregate the recognized feedback and provide an indication of that feedback to the presenters, the audience, or both.

For example, if the presenter tells a joke, various participants in the virtual meeting may laugh. Their laughter may be recognized by their respective client applications and indications of laughter reactions from those client applications are then sent to the virtual conference provider. Depending on the number of laughter reactions received by the virtual conference provider, it can output different effects to the presenters or participants. For example, the virtual conference provider could indicate the number of people laughing to the presenter and the audience, whose respective client applications may display graphical representations of laughter, such as a corresponding emoji or multiple emojis, depending on the number of laughter reactions. Alternatively, the virtual conference provider can transmit recorded video or audio (or both) of an audience laughing to the presenter or participants in the virtual meeting. By detecting the participants' reactions to the presenters and providing curated feedback of different kinds to the presenters, the presenters can feel engaged with the audience, while the audience can provide their feedback to the presenters.

This illustrative example is given to introduce the reader to the general subject matter discussed herein and the disclosure is not limited to this example. The following sections describe various additional non-limiting examples and examples of detecting audible reactions during virtual meetings.

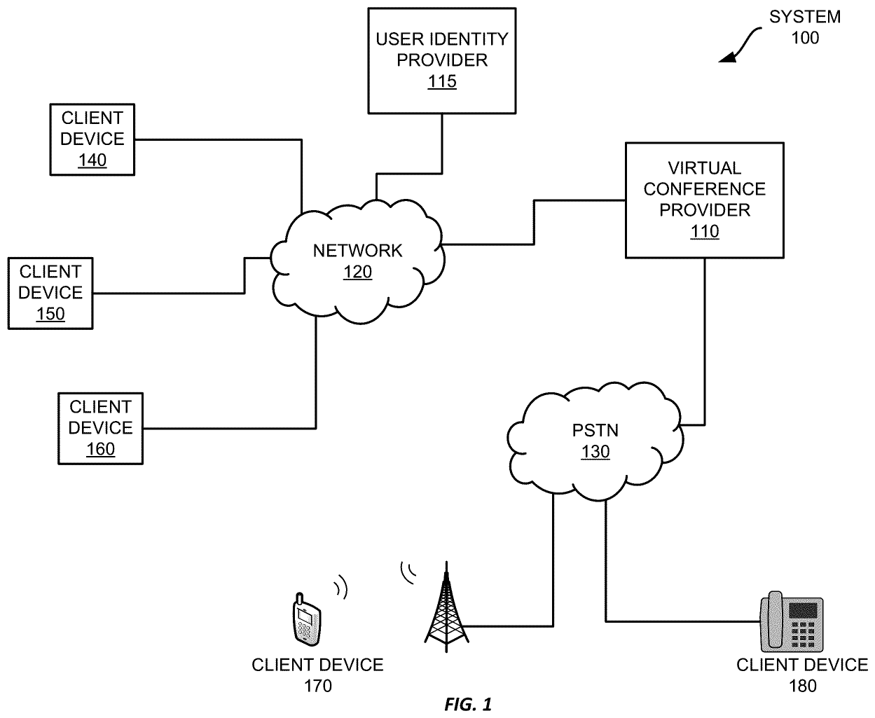

Referring now to FIG. 1, FIG. 1 shows an example system 100 that provides videoconferencing functionality to various client devices. The system 100 includes a virtual conference provider 110 that is connected to multiple communication networks 120, 130, through which various client devices 140-180 can participate in virtual conferences hosted by the virtual conference provider 110. For example, the virtual conference provider 110 can be located within a private network to provide video conferencing services to devices within the private network, or it can be connected to a public network, e.g., the internet, so it may be accessed by anyone. Some examples may even provide a hybrid model in which a virtual conference provider 110 may supply components to enable a private organization to host private internal virtual conferences or to connect its system to the virtual conference provider 110 over a public network.

The system optionally also includes one or more user identity providers, e.g., user identity provider 115, which can provide user identity services to users of the client devices 140-160 and may authenticate user identities of one or more users to the virtual conference provider 110. In this example, the user identity provider 115 is operated by a different entity than the virtual conference provider 110, though in some examples, they may be the same entity.

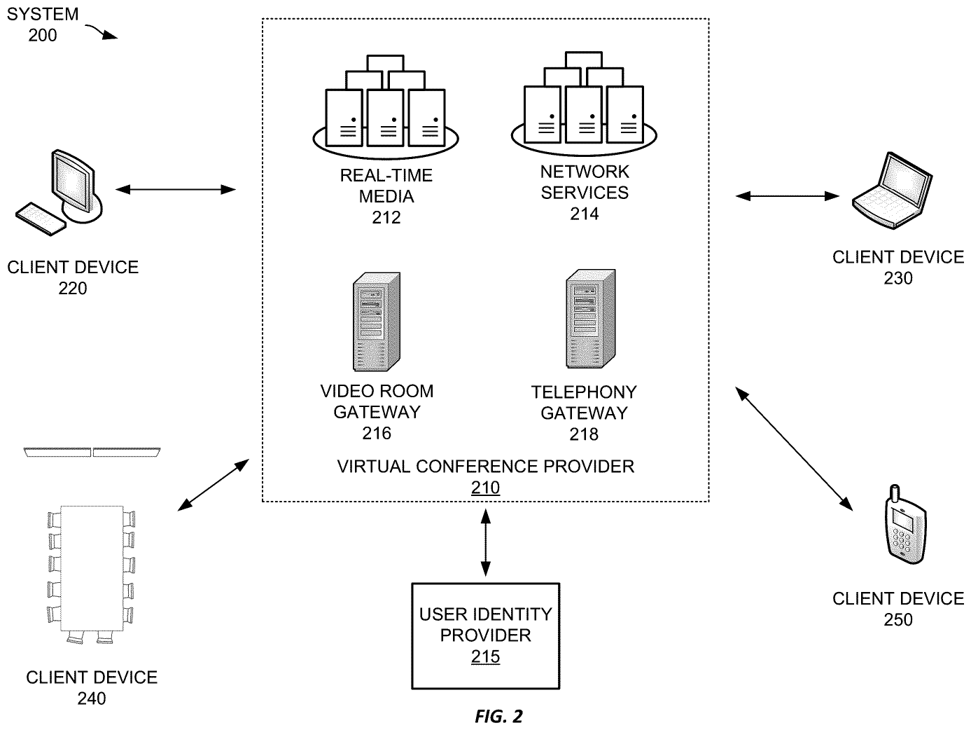

Virtual conference provider 110 allows clients to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the virtual conference provider 110.

Meetings in this example virtual conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “breakout” rooms. Such breakout rooms may also be rooms that are associated with a “main” videoconference room. Thus, participants in the main videoconference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the virtual conference provider 110, a user may contact the virtual conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the virtual conference provider 110 may prompt the user for certain information, such as a date, time, and duration for the meeting, a number of participants, a type of encryption to use, whether the meeting is confidential or open to the public, etc. After receiving the various meeting settings, the virtual conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The virtual conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the virtual conference provider 110. They also receive audio or video information from the virtual conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The virtual conference provider 110 may also invalidate the meeting information, such as the meeting identifier or password/passcode.

To provide such functionality, one or more client devices 140-180 may communicate with the virtual conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the virtual conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a virtual conference meeting hosted by the virtual conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the virtual conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the virtual conference provider 110 using network 120 and may provide information to the virtual conference provider 110 to access functionality provided by the virtual conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the virtual conference provider 110.

A user identity provider 115 may be any entity trusted by the virtual conference provider 110 that can help identify a user to the virtual conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the virtual conference provider 110.

When the user accesses the virtual conference provider 110 using a client device, the virtual conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the virtual conference provider 110 either provides or denies access to its services, respectively.

For telephony devices, e.g., client devices 170-180, the user may place a telephone call to the virtual conference provider 110 to access virtual conference services. After the call is answered, the user may provide information regarding a virtual conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the virtual conference provider 110. For example, telephony devices may be unable to provide user identification information to identify the telephony device or the user to the virtual conference provider 110. Thus, the virtual conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the virtual conference provider 110, even in cases where the user has an authenticated identity and employs a client device capable of identifying the user to the virtual conference provider 110. The virtual conference provider 110 may determine whether to allow such anonymous users to use services provided by the virtual conference provider 110. Anonymous users, regardless of the reason for anonymity, may be restricted as discussed above with respect to users employing telephony devices, and in some cases may be prevented from accessing certain meetings or other services, or may be entirely prevented from accessing the virtual conference provider 110.

Referring again to virtual conference provider 110, in some examples, it may allow client devices 140-160 to encrypt their respective video and audio streams to help improve privacy in their meetings. Encryption may be provided between the client devices 140-160 and the virtual conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the virtual conference provider 110, while allowing the virtual conference provider 110 to access the decrypted multimedia streams to perform certain processing, such as recording the meeting for the participants or generating transcripts of the meeting for the participants. End-to-end encryption may be used to keep the meeting entirely private to the participants without any worry about a virtual conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the virtual conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a virtual conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the virtual conference provider 210 over a communications network, such as the internet for client devices 220-240 or the PSTN for client device 250, generally as described above with respect to FIG. 1. The virtual conference provider 210 is also in communication with one or more user identity providers 215, which can authenticate various users to the virtual conference provider 210 generally as described above with respect to FIG. 1.

In this example, the virtual conference provider 210 employs multiple different servers (or groups of servers) to provide different aspects of virtual conference functionality, thereby enabling the various client devices to create and participate in virtual conference meetings. The virtual conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more virtual conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the virtual conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the virtual conference system 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the virtual conference provider 210 may receive multimedia streams from the various participants and publish those streams to the various participants to subscribe to and receive. Thus, the virtual conference provider 210 notifies a client device, e.g., client device 220, about various multimedia streams available from the other client devices 230-250, and the client device 220 can select which multimedia stream(s) to subscribe to and receive. In some examples, the virtual conference provider 210 may provide to each client device the available streams from the other client devices, but from the respective client device itself, though in other examples it may provide all available streams to all available client devices. Using such a multiplexing technique, the virtual conference provider 210 may enable multiple different streams of varying quality, thereby allowing client devices to change streams in real-time as needed, e.g., based on network bandwidth, latency, etc.

As mentioned above with respect to FIG. 1, the virtual conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the virtual conference provider 210 may allow a meeting participant to notify it of inappropriate behavior or content in a meeting. Such a notification may trigger the real-time media servers to 212 record a portion of the meeting for review by the virtual conference provider 210. Still other functionality may be implemented to take actions based on the decrypted multimedia streams at the virtual conference provider 210, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the virtual conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the virtual conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the virtual conference provider 210 under a supervisory set of servers. When a client device 220-250 accesses the virtual conference provider 210, it will typically communicate with one or more network services servers 214 to access their account or to participate in a meeting.

When a client device 220-250 first contacts the virtual conference provider 210 in this example, it is routed to a network services server 214. The client device may then provide access credentials for a user, e.g., a username and password or single sign-on credentials, to gain authenticated access to the virtual conference provider 210. This process may involve the network services servers 214 contacting a user identity provider 215 to verify the provided credentials. Once the user's credentials have been accepted, the client device 214 may perform administrative functionality, like updating user account information, if the user has an identity with the virtual conference provider 210, or scheduling a new meeting, by interacting with the network services servers 214.

In some examples, users may access the virtual conference provider 210 anonymously. When communicating anonymously, a client device 220-250 may communicate with one or more network services servers 214 but only provide information to create or join a meeting, depending on what features the virtual conference provider 210 allows for anonymous users. For example, an anonymous user may access the virtual conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the virtual conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the virtual conference provider 210. For example, the video conferencing hardware may be provided by the virtual conference provider 210 to one or more of its subscribers, which may provide access credentials to the video conferencing hardware to use to connect to the virtual conference provider 210.

The video room gateway servers 216 provide specialized authentication and communication with the dedicated video conferencing hardware that may not be available to other client devices 220-230, 250. For example, the video conferencing hardware may register with the virtual conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the virtual conference provider 210.

Referring now to the telephony gateway servers 218, these servers 218 enable and facilitate telephony devices' participation in meetings hosed by the virtual conference provider 210. Because telephony devices communicate using the PSTN and not using computer networking protocols, such as TCP/IP, the telephony gateway servers 218 act as an interface that converts between the PSTN and the networking system used by the virtual conference provider 210.

For example, if a user uses a telephony device to connect to a meeting, they may dial a phone number corresponding to one of the virtual conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the virtual conference provider 210 discussed above are merely examples of such devices and an example architecture. Some virtual conference providers may provide more or less functionality than described above and may not separate functionality into different types of servers as discussed above. Instead, any suitable servers and network architectures may be used according to different examples.

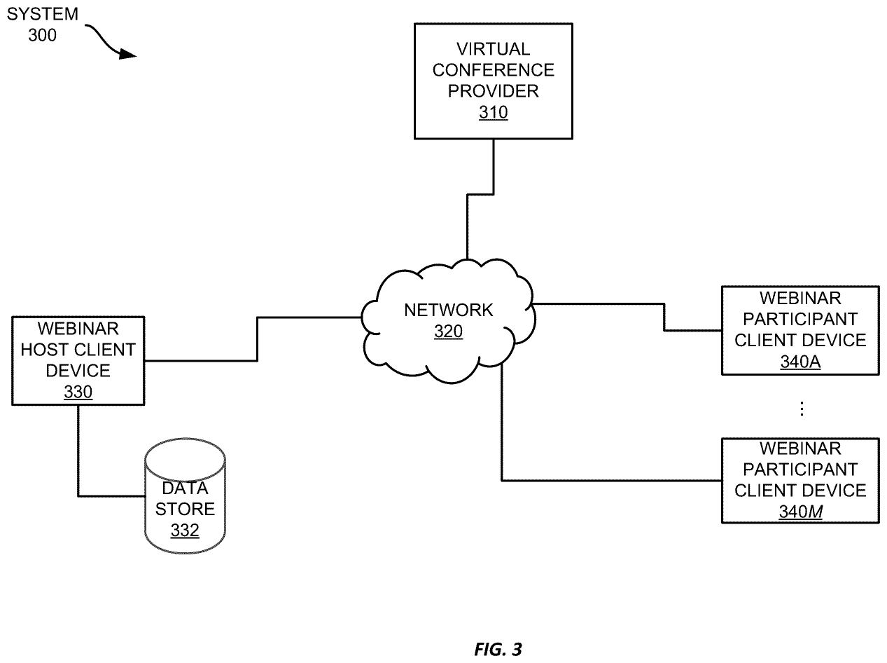

Referring now to FIG. 3, FIG. 3 shows an example system 300 for detecting audible reactions during virtual meetings. This example is in the context of a webinar virtual conference (or simply “webinar”); however, any type of virtual conference may be employed. In this example, a video conference provider 310, such as the video conference provider 110, 210 in FIG. 1 or 2, is connected to a communications network 320, such as the internet. A webinar host client device 330 and a number of webinar participant client devices 340a-m (m representing any number of webinar participant client devices in this example) are also connected to the network 320.

The webinar host client device 330 connects to the video conference provider 310 and begins a webinar meeting (or “webinar”) at the video conference provider 310, such as by beginning a scheduled webinar, generally as described above with respect to FIGS. 1 and 2. However, when scheduling the meeting, the host schedules the meeting as a webinar. In this example, the video conference provider 310 creates and manages webinar meetings similarly to how it handles conventional meetings as discussed above. However, because webinars generally are intended to operate one-way from the presenter(s) to the participants, the video conference provider 310 may limit certain functionality to general participants to the webinar.

For example, in a webinar the video conference provider 310 may prohibit participants from unmuting their microphone or from streaming video to the webinar for other participants to view. In addition, unlike in a conventional meeting, the participants in a webinar may not receive any information about other participants in the webinar. In a conventional meeting, participants may be able to interact with other participants and see their respective names, such as in close proximity to other participants' video streams or in a list of participants visible in a graphical user interface (“GUI”). Instead, in a webinar, the participants may only be able to see information, e.g., names or video feeds, from the host(s) of the webinar or certain select participants that will be engaged in discussions during the webinar, such as panelists in a panel discussion. Still other limits may be imposed on the various participants, such as their ability to react to occurrences during the webinar, e.g., participants may be allowed to interact with their GUI to raise their hand to ask a question, but may not be allowed to speak to the host(s).

When the video conference provider 310 begins the webinar, it creates a new meeting (including any applicable restrictions, such as those discussed above) and provides video and audio feeds that may be accessed by participants to receive video and audio content during the webinar. Participants, through their respective webinar participant client devices 340a-m, may join the webinar once it has started and connect to the available video and audio feeds.

During the course of the webinar, the webinar host client device 330 may present content to the participants, such as presentation material stored on the data store 332, through a video feed containing such presentation material or using a video feed of the presenter themself (or multiple such video feeds). If multiple different participants will present content, such as in a panel discussion or as co-presenters, such video feeds may be provided by other client devices that have been assigned a presenter or panelist role, such as by the host or by the video conference provider 310.

During the webinar, the participants view the presenter or other content via the client applications executing at their respective client devices 340a-m. However, due to restrictions imposed by the webinar host(s), they may not be allowed to provide audible feedback to the host(s). However, in this example, the client applications executed by the client devices 340a-m can capture audio, despite the restrictions imposed by the webinar host, and attempt to detect audible reactions during the webinar. If such reactions are detected, they may be provided to the video conference provider 310, which may then determine one or more aggregated reactions and provide them to the webinar host client device 330, the participant client devices 340a-m, or a combination of those devices. Thus, the webinar host(s) may perceive the participants' reactions, despite not otherwise having access to any participant audio feeds.

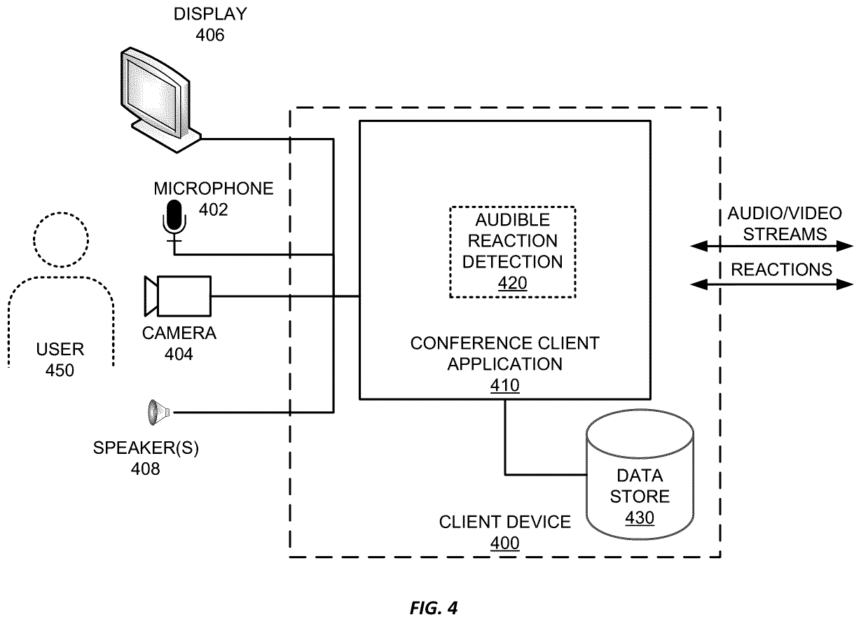

Referring now to FIG. 4, FIG. 4 shows a client device 400 that executes a virtual conference client application 410 (or “client application”). The client application provides functionality to enable the user 450 to join and participate in virtual conferences, as discussed above with respect to FIGS. 1-3. In addition, the client application 410 may allow other functionality, such as text chat functionality, conference scheduling, person-to-person voice chats (similar to a conventional telephone call), or any other suitable functionality.

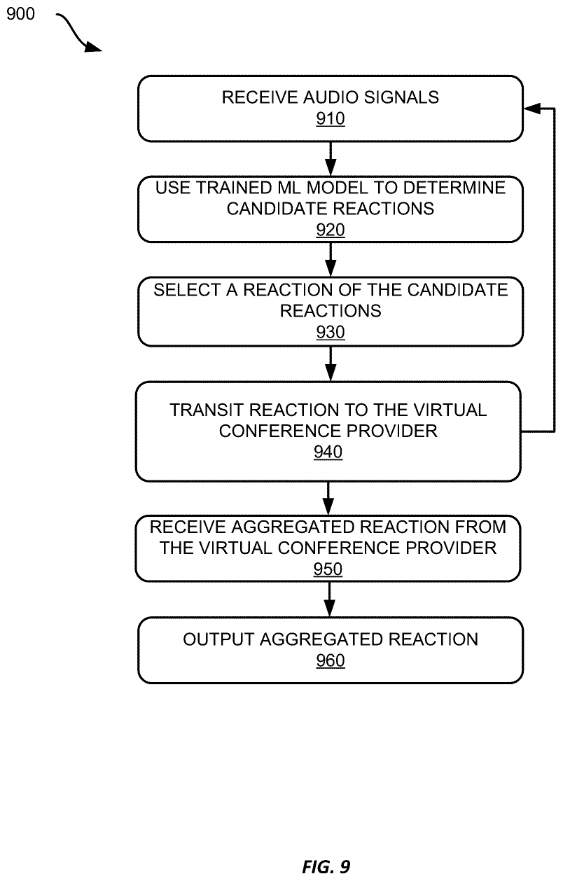

To enable this functionality, the client application 410 interacts with various input and output devices, such as a microphone 402 and camera 404, and display 406 and speaker(s) 408. The client application 410 can control the microphone 402 and camera 404 to capture audio and video streams to send to the virtual conference provider, the display 406 to present a graphical user interface (“GUI”) for the user 450 to interact with, which may include video output from received video streams, and the speaker(s) 408 to output received audio streams. In addition, the client application 410 may access a data store 420 to obtain audio or video clips corresponding to aggregated reactions, as will be described in more detail below with respect to FIG. 9.

In this example, the client application 410 includes an audible reaction detection system 420 that receives audio from the microphone 402 and attempts to detect audible reactions captured by the microphone 402, such as laughing, cheering, or applause. If an audible reaction is detected, it determines the type of reaction and provides an indication of the detected reaction to the virtual conference provider.

The client application 410 can also receive indications of aggregated reactions from the video conference provider. As will be discussed in more detail below, the video conference provider may receive indications of detected reactions from multiple different participants in a virtual meeting, which it may aggregate and provide to the participants, the host, panelists, presenters, or moderators in the virtual meeting for output.

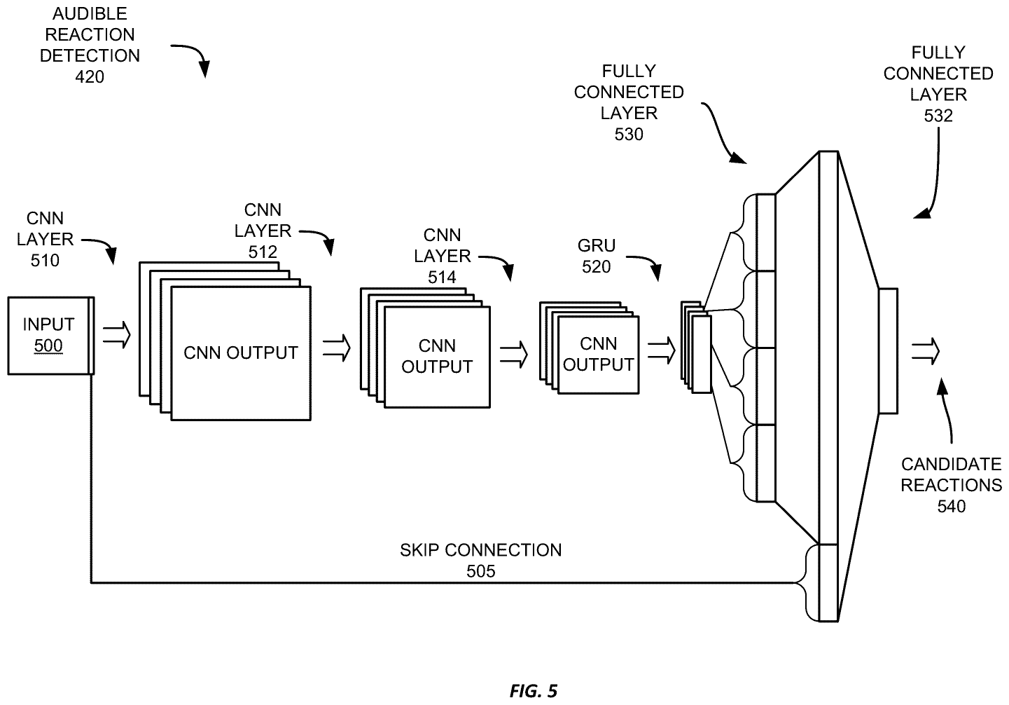

Referring now to FIG. 5, FIG. 5 illustrates an example audible reaction detection system 420 (or “reaction detection”) for detecting audible reactions during virtual meetings. The example reaction detection system 420 employs a trained machine-learning (“ML”) model to detect audible reactions captured by a microphone 402. The example ML model employs multiple convolutional neural network (“CNN”) layers 510-514 in series with a gated recurrent unit (“GRU”) 520 and two fully connected layers 530-532. Audio frames are provided as input 500 to the ML model via CNN layer 510, which the ML model processes and then outputs candidate reactions based on the applied input. The candidate reactions in this example includes probabilities associated with each of a set of possible reactions, however, in some examples, the output may be a single identified reaction, or an indication that no reaction was identified.

Input 500 is provided to CNN layer 510 as audio frames of suitable length, such as between 0.5 and 2 seconds. In this example, the input 500 is a raw audio signal that has been preprocessed to be in a suitable form for the ML model. The input audio frame includes multiple consecutive audio samples, such as 10 ms or 20 ms samples, that are preprocessed and combined. Preprocessing includes a time domain to frequency domain transformation, such as by using any suitable spectrogram, e.g., a Mel spectrogram. The frequency domain audio frame is then created by the concatenation of the successive frequency domain audio samples. As depicted in FIG. 5, one frequency domain audio sample—the most recent audio sample in the input 500 in this example—is also provided to the second fully connected layer 532 via a skip connection 505. The skip connection 505 is employed to more heavily emphasize the more recent audio when determining candidate reactions and helps improve the latency of reaction detection.

This example ML model employs three CNN layers 510-514, though a different number of CNN layers 510-514 may be employed according to different examples. In this example, the CNN layers 510-514 employ a kernel size of five and a stride of two, to increase the receptive field, but any suitable kernel size or stride may be used, such as a size of three or seven. Each CNN layer 510-514 also can employ a filter of size 32, 64, or 128, or any suitable size.

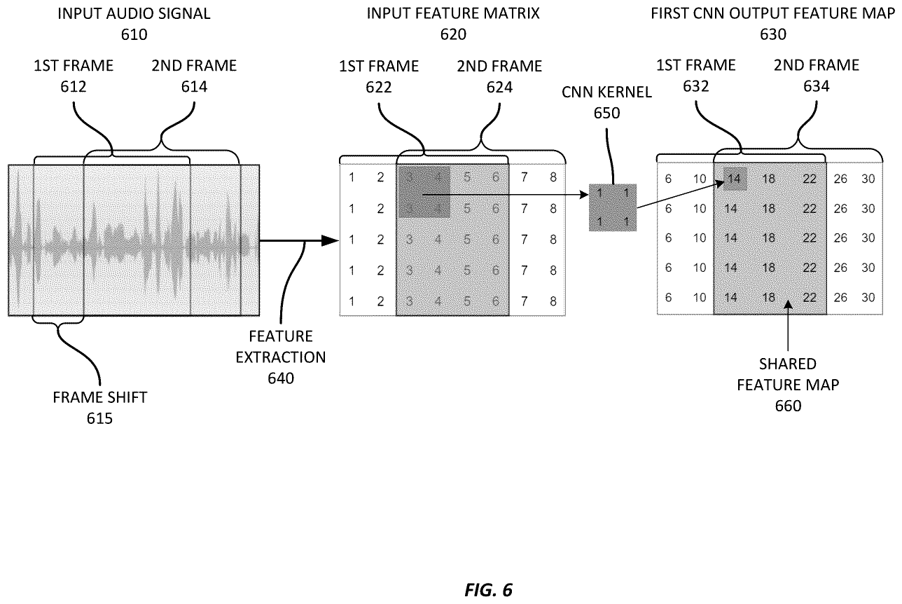

Referring now to FIG. 6, FIG. 6 illustrates an additional feature of the ML model that can improve computational cost and memory use. FIG. 6 illustrates an input audio sample 610 in the time domain, which is first converted to the frequency domain, as discussed above, and then used to generate an input feature matrix 620. The first CNN layer 510 then applies its CNN kernel 650 to the input feature matrix to generate the first CNN output feature map 630. However, the reaction detection system 420 uses overlapping audio frames as input to the ML model, as shown in FIG. 6: first frame 610 and second frame 620 overlap by an amount equal to the frame length minus the frame shift 615. Thus, the input feature matrix for the first frame 622 similarly overlaps with the input feature matrix for the second frame 624.

When the CNN kernel is applied to the first frame 622, it is applied to the entire frame. However, when the CNN kernel is applied to the second frame 624, it is only applied to the non-overlapping portions of the matrix (including partially overlapping portions), which reduces the number of computations based on the size of the overlapping region, which results in the two frames 632, 634 of the first CNN output feature map having a shared feature map 660 as illustrated. And while this example is shown in the context of two initial audio frames, it should be appreciated the subsequent frames may take advantage of similar efficiencies to reduce the total computational complexity of processing an input audio signal 610. For example, if an input audio signal is 0.5 seconds and the frame shift is 20 ms, computational complexity may be as little as 1/25th of performing processing on each input frame. Further, this technique is not restricted to the first CNN layer. Instead, it can be used by any subsequent CNN layers as well.

Referring again to FIG. 5, after the ML model operates on an input 500, it generates and outputs candidate reactions 540 as discussed above, which in this case represent probabilities of each possible reaction. During a virtual conference, the reaction detection system 420 will be executed iteratively with successive audio samples supplied as input 500 to the ML model, resulting in a series of candidate reactions 540 being output. For each set of candidate reactions 540, the reaction detection system 420 determines a candidate reaction, or that no reaction was detected. In this example, the reaction detection system 420 identifies the reaction having the highest probability, above a minimum threshold probability, as being the detected reaction. A minimum threshold may be used to prevent instances where no reaction is present, such as a threshold greater than 0.5 (e.g., 0.51 or 0.6, where the output values range from 0 to 1.0), though small non-zero probabilities may be output by the ML model in some examples. However, in some examples, a minimum threshold probability may not be used and the candidate reaction with the highest probability may be output as the detected reaction. In this example, if no probability exceeds the minimum threshold, the reaction detection system 420 determines that no reaction was detected.

Over iterated operations, the audible reaction detection system outputs a sequence of detected reactions (or no reactions), which may be provided as a detected reaction to the virtual conference provider. In some examples, the client application 410 may receive the sequence of detected reactions and, after a threshold number of successive consistent reactions are detected, it may provide the detected reaction to the virtual conference provider. It may continue to provided that detected reaction to the virtual conference provider while it continues to be detected by the reaction detection system 420. After a threshold number of new detected reactions, or detected no-reaction, the client application 410 may change the indicated reaction, or stop providing an indication of reaction to the virtual conference provider. Thus, the client application 410 may provide real-time indications of detected reactions to the virtual conference provider for the duration the reaction is detected. This can enable the virtual conference provider to provide contemporaneous and accurate reactions to one or more participants in the virtual conference.

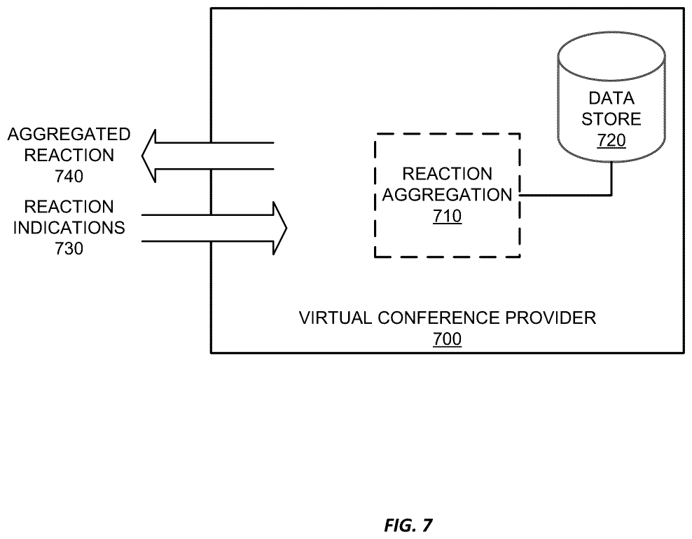

Referring now to FIG. 7, FIG. 7 shows an example virtual conference provider 700 with reaction aggregation functionality. The virtual conference provider 700 is configured to establish and host virtual conference, generally as discussed above with respect to FIGS. 1-3. In addition, the virtual conference provider 700 includes reaction aggregation system 710, which is connected to a data store 720. The reaction aggregation system 710 receives indications of reactions 730 from participants in virtual conferences and determines aggregated reactions 740 to provide to the participants based on the received indications of reactions 730.

The reaction aggregation system 710 receives incoming reaction indications from various participants and determines those that are part of a common virtual conference. For a particular virtual conference, the reaction aggregation system 710 then determines a number of reaction indications 730 of the same type that have been received. It may then compare the number to one or more thresholds. Alternatively, it may compute other metrics, such as a percentage of the participants providing the reaction. The thresholds in this example include the following:

| Reaction Indications | |
|---|---|
| (Applause) | Aggregated Reaction |
| 5% | None |
| 15% | Light applause |
| 25% | Moderate |
| 40% | Strong applause |

Thus, the virtual conference provider 700 may determine a number of participants providing a particular type of reaction as a percentage of the total participants. Depending on which threshold is exceeded, the virtual conference provider 710 may provide a corresponding aggregated reaction. The nature of the aggregated reaction may be fixed or it may be determined by the host of the meeting or another entity. For example, an aggregated reaction may indicate one or more reaction emojis to display within a participant's GUI. Light applause may present a single clapping emoji, while strong applause may present multiple clapping emojis. In addition, the aggregated reaction may include pre-recorded audio corresponding to light, moderate, or strong applause, which may be output concurrently with the reaction emojis or instead of the reaction emojis. Similarly, the aggregated reaction may include pre-recorded video of an audience, such as stored in the data store 720, applauding at different intensities that may be presented as a temporary background for the presenter or the host.

If multiple different types of reaction indications are received, the virtual conference provider 700 may process each independently and provide a corresponding reaction indication 740 for each. Thus, aggregated reactions 740 may be provided for each type of reaction for which the reaction indications exceed a corresponding threshold. A participant may thus view each type of reaction and its corresponding intensity. In examples where audio or video reactions are provided, pre-recorded audio or video having combinations of reactions may be employed—such as for an audience that is applauding and cheering. In some examples, the reaction aggregation system 710 may only generate an aggregated reaction 740 for the type of reaction having the highest intensity. Thus, the virtual conference provider 700 can provide aggregated reactions based on the received reaction indications. Further, it should be appreciated that because reaction indications 730 are received substantially in real-time from the participants, and because the number and types of reaction indications 730 received may vary over time, the reaction aggregation system 710 may execute continuously or iteratively to generate aggregated reactions that may change over time, depending on the received reaction indications 830.

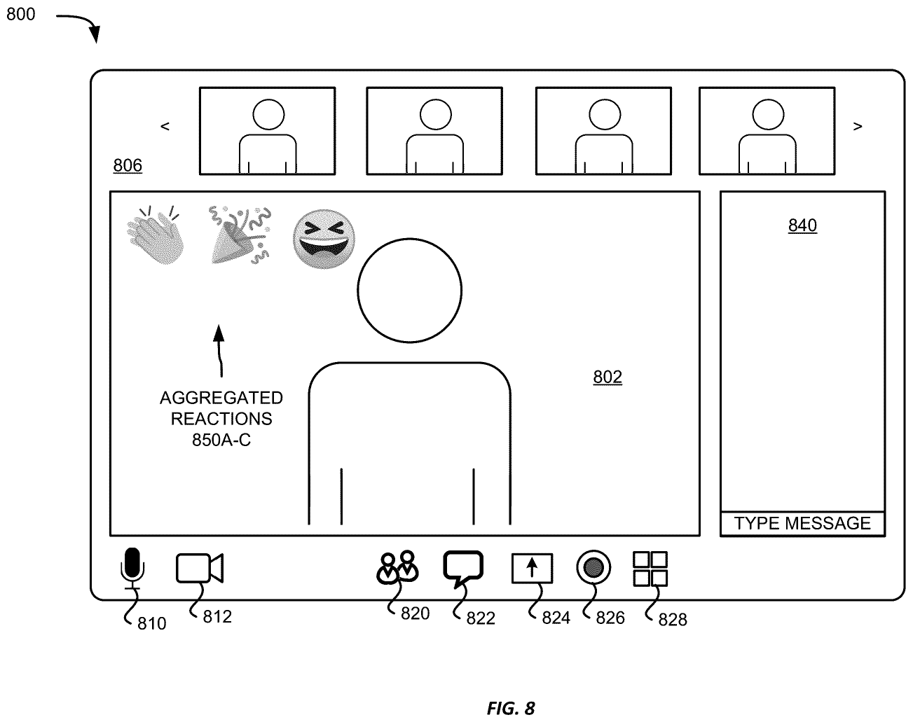

Referring now to FIG. 8, FIG. 8 shows an example GUI 800 that can provide reactions during virtual meetings. A client device, e.g., client device 400, executes a software client 410, which in turn displays the GUI 800 on the client device's display. In this example, the GUI 800 includes a speaker view window 802 that presents the current speaker in the virtual conference. Above the speaker view window 802 are smaller participant windows 806, which allow the participant to view some of the other participants in the virtual conference, as well as controls (“<” and “>”) to let the host scroll to view other participants in the virtual conference.

Beneath the speaker view window 802 are a number of interactive elements 810-830 to allow the participant to interact with the virtual conference software. Controls 810-812 may allow the participant to toggle on or off audio or video streams captured by a microphone or camera connected to the client device. Control 820 allows the participant to view any other participants in the virtual conference with the participant, while control 822 allows the participant to send text messages to other participants, whether to specific participants or to the entire meeting. Control 824 allows the participant to share content from their client device. Control 826 allows the participant toggle recording of the meeting, and control 828 allows the user to select an option to join a breakout room. Finally, chat window 840 provides for the various participants to engage in text messaging during the virtual conference.

During a virtual conference, the participant views the presenter in the speaker view window 802. In large virtual conferences or webinars, the GUI 800 may not include the smaller participant windows 806 or the chat window 840. Instead, the viewer may only see the presenter. As discussed above, in such virtual conferences, the virtual conference provider may not allow participants to share audio or video streams with other participants or the presenter, even if the user's microphone and camera are enabled. However, the client application 410 may receive audio from the microphone and attempt to detect a reaction. In addition, the virtual conference provider may provide aggregated reactions 850a-c to the participants in the virtual conference. The aggregated reactions may be displayed as one or more emojis overlaid on the speaker view window 802. In this example, three different aggregated reactions have been provided, one each for applause, cheering, and laughing. It should be appreciated that while the example above discusses large virtual conferences and webinars, these techniques may be used in any type of virtual meeting.

As discussed above, an aggregated reaction may indicate an intensity of the reaction. Thus, if there is heavy applause, for example, the client application 410 may output multiple applause emojis. The number of emojis output for a particular aggregated reaction may be based on the number of received reaction indications, a percentage of the participants providing such a reaction, or other factors.

And while this example includes emojis, the virtual conference provider may instead provide an audio or video aggregated reaction. An audio aggregated reaction may be output by the client device's speakers or displayed as a background within the speaker view window 802 with the speaker overlaid on the background. To provide the background, the virtual conference provider may either provide the background to the presenter's client device, such as by pre-downloading one or more before the virtual meeting begins or dynamically downloading one or more during the virtual meeting, and then commanding the client application at the presenter's client device to use one of backgrounds. Alternatively, the virtual conference provider may apply the background to the presenter's video stream by overlaying their body onto the background. The altered video stream may then be provided to the participants in the virtual meeting.

Referring now to FIG. 9, FIG. 9 shows an example method 900 for detecting audible reactions during virtual meetings. This example will be discussed with respect to the system shown in FIG. 3, the client device 400 shown in FIG. 4, and the audible reaction detection system 420 shown in FIG. 5; however, any suitable systems, client devices, or audible reaction detection systems may be used according to this disclosure.

At block 910, a client application 410 receives audio signals from a microphone 402 in communication with the client device 400.

At block 920, the client application 410 employs a trained ML model to determine one or more candidate reactions based on the received audio signals. As discussed above with respect to FIG. 5, the client application provides audio frames to the audible reaction detection system 420, which includes a trained ML model. The audio frames in this example include 0.5 s of audio samples, where each audio sample is 10 ms. The audio data in the audio frames is converted into the frequency domain from the time domain and provided as input 500 to the ML model.

As discussed above, the input 500 is provided to a sequence of CNN layers 510-514. As discussed above with respect to FIG. 6, each CNN layer outputs a respective CNN output feature map, which is provided to the next CNN layer. The last CNN layer, CNN layer 514 in this example, provides it output to a GRU 520, which in turn provides its output to a fully connected layer 530. In this example, two fully connected layers 530-532 are used. The output of the first fully connected layer 530 is provided to the second fully connected layer 532. In addition, the most recent audio frame within the input 500 is provided to the second fully connected layer 532 by a skip connection 505, as discussed above. The second fully connected layer 532 then outputs a tuple including probabilities corresponding to different reactions that the ML model has been trained to recognize.

In this example, the ML model has been trained to recognize applause, cheering, and laughter. Thus, an example output tuple may include four values: {P_{A}, P_{C}, P_{L}, P_{NR}), where P_{A} represents a probability that applause was recognized, P_{C} represents a probability that cheering was recognized, P_{L} represents a probability that laughter was recognized, P_{NR} represents a probability that no reaction was present. Because the output tuple includes probabilities, in this example, P_{A}, P_{C}, P_{L}, and P_{NR} sum to 1. Other examples may not output a P_{NR}. Instead, any difference between 1 and the sum of the outputted probabilities, e.g., P_{A}, P_{C}, and P_{L}, implicitly indicates a probability that no reaction was present.

It should be appreciated that while this example has a ML model trained to recognized three particular types of reactions, any suitable reactions may be used to train an ML model. Further, ML models may be trained on any number of reactions, including more or less than three.

At block 930, the client application 410 selects a reaction from the candidate reactions. In this example, the client application selects the candidate reaction having the highest probability, which may include a “no reaction” reaction. In some examples, the client application selects the candidate reaction, excluding the “no reaction,” that exceed a threshold. For example, if the ML model outputs P_{A}=0.48, P_{C}=0.07, and P_{L}=0.03, the implied “no reaction” reaction has a value of 0.42. But if the client application 410 employs a threshold of 0.40, it may select the P_{A} reaction. Alternatively, the client application may select the reaction having the highest probability that also exceeds the “no reaction” reaction probability. Still other techniques may be used to select a reaction from the candidate reactions.

At block 940, the client application 410 transmits an indication of the selected reaction to the virtual conference provider. The method 900 then continues to iterate by receiving additional audio signals at block 910. It should be appreciated that the client application 410 may not wait to complete block 940 to continue receiving audio signals. Instead, the processes may continue in parallel with new audio samples being captured and provided to the trained ML model concurrently with the trained ML model processing a previously received input 500.

At block 950, the client application receives an aggregated reaction from the virtual conference provider. As discussed above with respect to FIGS. 7 and 8, an aggregated reaction may identify the aggregated reaction as well as an intensity, though in some examples, no intensity may be provided. In this example, the client application 950 receives an identification of the aggregated reaction, such as an identification of an “applause” reaction and an intensity of the applause, such as “moderate” applause. However, in some examples, the received aggregated reaction may be an audio stream or video stream that includes audio or video, respectively, to output a simulated reaction, such as simulated applause, laughter, or cheering. Further, the audio or video may be identified as an aggregated reaction or it may be previously incorporated into an existing audio or video feed, such as by being incorporated into the presenter's audio or video feed by the presenter's client device or the virtual conference provider.

At block 960, the client application 410 outputs the aggregated reaction. The output may be visual, such as by displaying one or more emojis overlaid on to a speaker view window 802 or elsewhere within the GUI 800, or by outputting a graphical background, e.g., a static or animated background or a video showing a pre-recorded audience reaction, in the speaker view window 802 on which the presenter is overlaid. It should be appreciated that the presenter may be overlaid on a graphical background by the presenter's client device, by the virtual conference provider, or by the receiving client device 400. The corresponding computing device may identify portions of the presenter's video feed corresponding to the presenter's own body. It may then extract that portion of the video feed and overlay it onto the selected background. If the overlay occurs at the presenter's client device or the virtual conference provider, the video stream may then be transmitted to one or more participants client devices in the virtual meeting.

In some examples, the client application 410 may output audio corresponding to the aggregated reaction. For example, the client application 410 may access a data store 420 having one or more audio clips corresponding to different aggregated reactions and may select the audio clip corresponding to the identified aggregated reaction and output it via the client device's speakers 408. It should be appreciated that while this example was discussed with respect to a single aggregated reaction being received and output, in some examples multiple aggregated reactions may be received and output concurrently with each other.

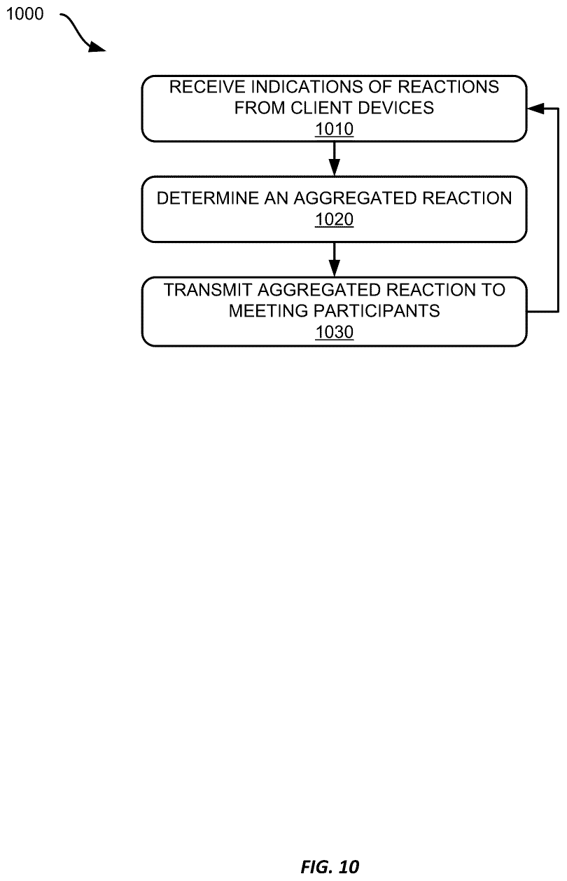

Referring now to FIG. 10, FIG. 10 shows an example method 1000 for detecting audible reactions during virtual meetings. The example method 1000 will be discussed with respect to the example system 700 shown in FIG. 7; however, any suitable system according to this disclosure may be employed.

At block 1010, the virtual conference provider 700 receives indications of reactions from one or more client devices during a virtual conference. In this example, the client devices provide indications of reactions as discussed above with respect to FIGS. 3-5 and 9. It should be appreciated that multiple different types of reactions may be indicated by different client devices within the same virtual conference.

At block 1020, the virtual conference provider 700 determines an aggregated reaction based on the received indications of reactions. The virtual conference provider 700 may employ a reaction aggregation system 700 to determine one or more aggregated reactions, generally as described above with respect to FIG. 7.

At block 1030, the virtual conference provider 700 transmits one or more aggregated reactions to client devices associated with participants within the virtual conference. In this example, the virtual conference provider 700 transmits an identification of the aggregated reaction, such as “applause” or “cheering,” and an intensity of the aggregated reaction, such as “light” or “heavy.” In some examples, however, the virtual conference provider 700 may provide an audio or video feed including one or more aggregated reactions. For example, the virtual conference provider 700 may access a data store 720 that includes pre-recorded reaction audio or video, such as pre-recorded cheering or applause or pre-recorded video of an applauding audience. Further, in some examples, audio may be generated on the fly by the video conference provider from sound clips, or video may be an animation rather than pre-recorded live video. And while certain examples have been discussed above, still other examples are within the scope of this disclosure.

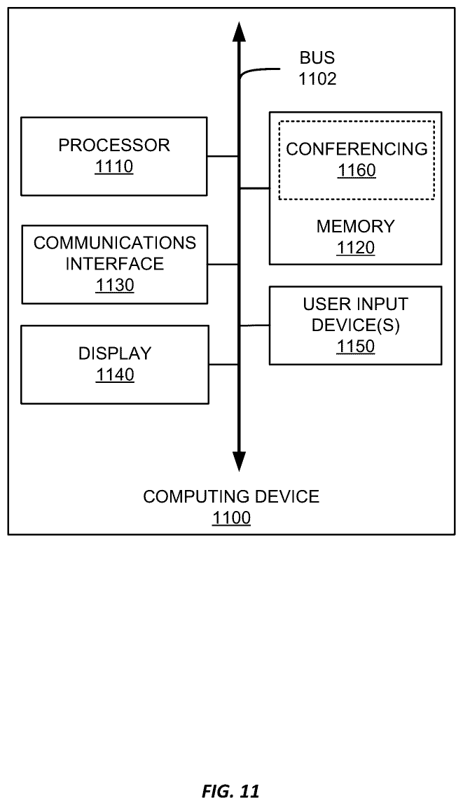

Referring now to FIG. 11, FIG. 11 shows an example computing device 1100 suitable for use in example systems or methods for detecting audible reactions during virtual meetings according to this disclosure. The example computing device 1100 includes a processor 1110 which is in communication with the memory 1120 and other components of the computing device 1100 using one or more communications buses 1102. The processor 1110 is configured to execute processor-executable instructions stored in the memory 1120 to perform one or more methods for detecting audible reactions during virtual meetings according to different examples, such as part or all of the example methods 900, 1000 described above with respect to FIGS. 9-10. The computing device 1100, in this example, also includes one or more user input devices 1150, such as a keyboard, mouse, touchscreen, microphone, etc., to accept user input. The computing device 1100 also includes a display 1140 to provide visual output to a user.

In addition, the computing device 1100 includes a conferencing client application 1160 to enable a user to join and participate in one or more virtual conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 1100 also includes a communications interface 1140. In some examples, the communications interface 1130 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving, by a machine learning (“ML”) model of a conference client application, audio signals received from a microphone of a client device, the client device connected to a virtual meeting via the conference client application, the virtual meeting hosted by a virtual conference provider;
determining, by the ML model, a plurality of candidate reactions associated with the audio signals, the ML comprising a plurality of convolutional neural network (“CNN”) layers and at least one fully connected layer;
selecting a reaction from the plurality of candidate reactions; and
transmitting the reaction to the virtual conference provider.

2. The method of claim 1, wherein the ML model further comprises a gated recurrent unit between the plurality of CNN layers and the at least one fully connected layer.

3. The method of claim 1, wherein the ML model further comprises a skip connection between an input node of the ML model and a first fully connected layer of the at least one fully connected layers.

4. The method of claim 1, further comprising selecting the reaction having a greatest probability of the plurality of candidate reactions.

5. The method of claim 1, further comprising selecting the reaction exceeding a first threshold and having a greatest probability of the plurality of candidate reactions.

6. The method of claim 1, wherein the ML model further comprises a plurality of fully connected layers.

7. The method of claim 1, wherein the plurality of candidate reactions comprises a clapping reaction, a cheering reaction, or a laughing reaction.

8. The method of claim 1, further comprising:
receiving an aggregated reaction from the virtual conference provider; and
outputting one or more graphical representations of the aggregated reaction.

9. The method of claim 8, wherein the aggregated reaction comprises a clapping reaction, a cheering reaction, or a laughing reaction.

10. A system comprising:
a non-transitory computer-readable medium;
a communications interface; and
one or more processors communicatively coupled to the non-transitory computer-readable medium and the communications interface, the one or more processors configured to execute processor-executable instructions stored in the non-transitory computer-readable medium to:
receive, by a machine learning (“ML”) model of a conference client application, audio signals received from a microphone of a client device, the client device connected to a virtual meeting via the conference client application, the virtual meeting hosted by a virtual conference provider;
determine, by the ML model, a plurality of candidate reactions associated with the audio signals, the ML comprising a plurality of convolutional neural network (“CNN”) layers and at least one fully connected layer;
select a reaction from the plurality of candidate reactions; and
transmit the reaction to the virtual conference provider.

11. The system of claim 10, wherein the ML model further comprises a gated recurrent unit between the plurality of CNN layers and the at least one fully connected layer.

12. The system of claim 10, wherein the ML model further comprises a skip connection between an input node of the ML model and a first fully connected layer of the at least one fully connected layers.

13. The system of claim 10, wherein the one or more processors are configured to execute further processor-executable instructions stored in the non-transitory computer-readable medium to select the reaction having a greatest probability of the plurality of candidate reactions.

14. The system of claim 10, wherein the one or more processors are configured to execute further processor-executable instructions stored in the non-transitory computer-readable medium to select the reaction exceeding a first threshold and having a greatest probability of the plurality of candidate reactions.

15. The system of claim 10, wherein the ML model further comprises a plurality of fully connected layers.

16. A non-transitory computer-readable medium comprising processor-executable instructions configured to cause a processor to:
receive, by a machine learning (“ML”) model of a conference client application, audio signals received from a microphone of a client device, the client device connected to a virtual meeting via the conference client application, the virtual meeting hosted by a virtual conference provider;
determine, by the ML model, a plurality of candidate reactions associated with the audio signals, the ML comprising a plurality of convolutional neural network (“CNN”) layers and at least one fully connected layer;
select a reaction from the plurality of candidate reactions; and
transmit the reaction to the virtual conference provider.

17. The non-transitory computer-readable medium of claim 16, wherein the ML model further comprises a gated recurrent unit between the plurality of CNN layers and the at least one fully connected layer.

18. The non-transitory computer-readable medium of claim 16, wherein the ML model further comprises a skip connection between an input node of the ML model and a first fully connected layer of the at least one fully connected layers.

19. The non-transitory computer-readable medium of claim 16, wherein the one or more processors are configured to execute further processor-executable instructions stored in the non-transitory computer-readable medium to select the reaction having a greatest probability of the plurality of candidate reactions.

20. The non-transitory computer-readable medium of claim 16, wherein the one or more processors are configured to execute further processor-executable instructions stored in the non-transitory computer-readable medium to select the reaction exceeding a first threshold and having a greatest probability of the plurality of candidate reactions.
